(19) United States
(12) Patent Application Publication
(10) Pub. No.: US 2026/0009654 A1
(43) Pub. Date: Jan. 8, 2026

(54) MAP GENERATION APPARATUS

(71) Applicant: Honda Motor Co., Ltd., Tokyo (JP)

(72) Inventor: Naoki Mori, Wako-shi, Saitama (JP)

(21) Appl. No.: 18/852,807

(22) PCT Filed: Mar. 31, 2022
(86) PCT No.: PCT/JP2022/016508

§ 371 Date: Feb. 26, 2025

(51) Int. Cl. G01C 21/00; G06T 7/73

(52) U.S. Cl. CPC G01C 21/3811; G01C 21/3837; G06T 7/73; G06T 2207/10028; G06T 2207/30244; G06T 2207/30252

(57) ABSTRACT

A map generation apparatus including an in-vehicle detector detecting a situation around a subject vehicle and a microprocessor. The microprocessor is configured to perform extracting feature points from detection information detected by the in-vehicle detector, selecting first feature points from the feature points, calculating three-dimensional positions of the first feature points included in each of a plurality of the detection information while estimating a position or posture of the in-vehicle detector based on the plurality of the detection information, and generating a map including information of the three-dimensional positions of the first feature points. The microprocessor is configured to perform the selecting including selecting the first feature points other than a feature point of a predetermined landscape feature from the feature points, and the generating including adding information on a position of a second feature point not selected among the feature points to the map.

### CROSS-REFERENCE TO RELATED APPLICATION

This application is a National Stage of PCT international application Ser. No. PCT/JP2022/016508 filed on Mar. 31, 2022 which designates the United States, incorporated herein by reference.

### TECHNICAL FIELD

This invention relates to a map generation apparatus configured to generate a map used for estimating a position of a subject vehicle.

### BACKGROUND ART

As this type of apparatus, conventionally, there is a known apparatus that is configured to generate a map using feature points extracted from images captured by a camera mounted on a vehicle during traveling (see Patent Literature 1, for example).

### CITATION LIST

### Patent Literature

Patent Literature 1: Japanese Unexamined Patent Publication No. 2019-174910

### DISCLOSURE OF INVENTION

### Problems to be Solved by the Invention

In prior art, when the map is corrected while repeating travel of the vehicle, the accuracy of information in the map may be compromised.

### Means for Solving Problem

An aspect of the present invention is a map generation apparatus including an extraction unit configured to extract feature points from detection information detected by an in-vehicle detector detecting a situation around a subject vehicle, a selection unit configured to select feature points used in a calculation by a calculation unit from the feature points extracted by the extraction unit, the calculation unit configured to calculate a three-dimensional position of a same feature point included in a plurality of the detection information for each of the feature points different from each other selected by the selection unit using a position and posture of the in-vehicle detector based on the detection information, and a generation unit configured to generate a map including information of respective three-dimensional positions of the feature points different from each other using the three-dimensional positions of the feature points calculated by the calculation unit. The selection unit is configured to select the feature points other than the feature points of a predetermined landscape feature, and the generation unit is configured to add information of points corresponding to the feature points not selected by the selection unit to the map generated.

### Effect of the Invention

According to the present invention, it is possible to appropriately generate a map required for safe vehicle control.

### BRIEF DESCRIPTION OF THE DRAWINGS

FIG. 1 is a block diagram schematically illustrating an overall configuration of a vehicle control system according to an embodiment of the present invention;

FIG. 2 is a block diagram illustrating a main configuration of a map generation apparatus according to the embodiment;

FIG. 3A is a diagram illustrating an example of a camera image;

FIG. 3B is a diagram illustrating an example of extracted feature points;

FIG. 3C is a diagram illustrating an example of selected feature points;

FIG. 4A is a flowchart illustrating an example of processing executed by a controller in accordance with a program;

FIG. 4B is a flowchart illustrating another example of processing executed by the controller in accordance with a program;

FIG. 5A is a schematic diagram for explaining information included in an environmental map at the time when processing of step S70 ends; and

FIG. 5B is a schematic diagram for explaining information included in the environmental map at the time when processing of step S80 ends.

### DESCRIPTION OF EMBODIMENT

Hereinafter, an embodiment of the present invention is explained with reference to drawings. A map generation apparatus according to an embodiment of the invention can be applied to, for example, a vehicle having a self-driving capability, i.e., self-driving vehicle. The vehicle having the map generation apparatus may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary but also in a manual drive mode in which the driving operation by the driver is necessary.

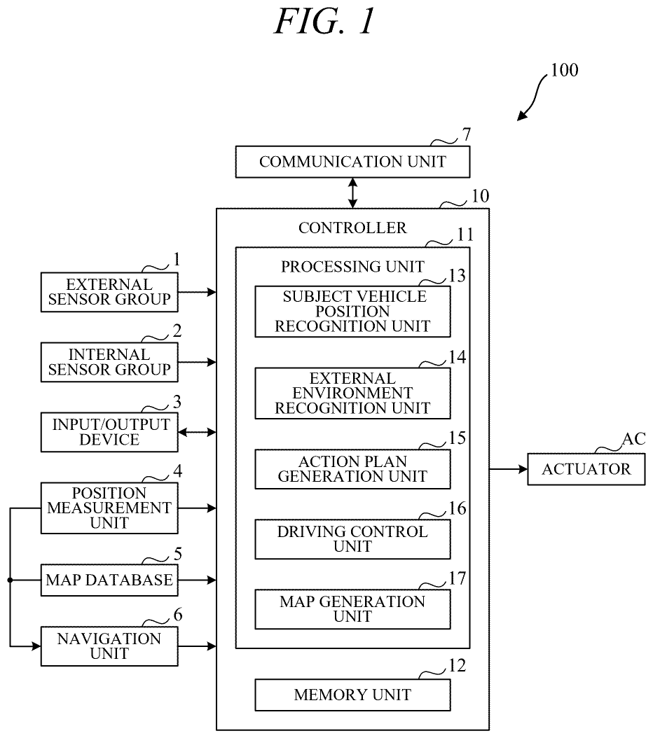

First, a configuration for the self-driving of the subject vehicle will be schematically explained. FIG. 1 is a block diagram schematically illustrating an overall configuration of a vehicle control system 100 of the subject vehicle having the map generation apparatus according to an embodiment of the present invention. As illustrated in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR for measuring distance from the subject vehicle to ambient obstacles by measuring scattered light produced by laser light radiated from the subject vehicle in every direction, a RADAR for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting acceleration in front-rear direction and acceleration in left-right direction (lateral acceleration) of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a magnetic disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 5. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. In addition to acquiring travel history information, travel history information of the subject vehicle may be transmitted to the server via the communication unit 7. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for operating a turning device.

The controller 10 is configured by an electronic control unit (ECU). More specifically, the controller 10 incorporates a computer including a CPU or other processing unit (a microprocessor) 11 for executing a processing in relation to travel control, the memory unit 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (referred to as high-accuracy map information). The high-accuracy map information includes information on road position, information on road shape (curvature, etc.), information on gradient of the road, information on position of intersections and branches, information on type and position of division line such as white line, information on the number of lanes, information on width of lane and the position of each lane (center position of lane and boundary line of lane), information on position of landmarks (buildings, traffic signals, traffic signs, etc.) as a mark on the map, and information on the road surface profile such as unevennesses of the road surface, etc. In the embodiment, center lines, lane boundary lines, road outside lines are collectively referred to as division lines of road.

The high-accuracy map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2.

The external map information is, for example, information of a map (called a cloud map) acquired through a cloud server, and the internal map information is information of a map (called an environmental map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone). For roads not yet traveled by the subject vehicle and newly constructed roads, etc., an environmental map is created by the subject vehicle itself. It is also possible to provide the internal map information to a server device and other vehicles via the communication unit 7.

In addition to the high-accuracy map information mentioned above, the memory unit 12 also stores travel trajectory information of the subject vehicle, information on various control programs and thresholds used in the programs.

As functional configurations, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes (or may be called estimates) the position of the subject vehicle (subject vehicle position) on the map based on position information of the subject vehicle calculated by the position measurement unit 4 and map information stored in the map database 5.

Optionally, the subject vehicle position can be recognized (or estimated) using high-accuracy map information stored in the memory unit 12 and ambience data of the subject vehicle detected by the external sensor group 1, whereby the subject vehicle position can be recognized with high accuracy.

It is also possible to recognize the subject vehicle position by calculating movement information (movement direction, movement distance) of the subject vehicle based on the detection values of the internal sensor group 2. Optionally, when the subject vehicle position can be measured by sensors installed externally on the road or by the roadside, the subject vehicle position can be recognized by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic signals, road division lines (white lines, etc.) and stop lines, buildings, guardrails, power poles, commercial signs, pedestrians, bicycles, and the like. Recognized states of other objects include, for example, traffic signal color (red, green or yellow) and moving speed and direction of pedestrians and bicycles. Some of the stationary objects among the other objects constitute landmarks that serve as indicators of positions on a map, and the external environment recognition unit 14 also recognizes the position and type of the landmarks.

The action plan generation unit 15 generates a driving path (target path) of the subject vehicle from present time point to a certain time ahead based on, for example, a target route computed by the navigation unit 6, high-accuracy map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environmental map of the area surrounding the road traveled by the subject vehicle as internal map information using the detection values detected by the external sensor group 1 while traveling in the manual drive mode. For example, an edge indicating an outline of an object is extracted from multiple frames of camera image acquired by the camera, based on luminance and color information for each pixel, and a feature point is extracted using the edge information. The feature point is, for example, an intersection of the edges, and corresponds to a corner of a building, a corner of a traffic sign, or the like. The map generation unit 17 calculates the three-dimensional position for a feature point while estimating the position and posture of the camera so that the same feature point converges to a single point across multiple frames of the camera image in accordance with the algorithm of SLAM technology. By performing this calculation process for each of the multiple feature points, an environmental map constituted by three-dimensional point group data is generated.

The environmental map may be generated by extracting the feature points of an object around the subject vehicle using data acquired by radar or LIDAR instead of the camera.

Further, when generating the environmental map, if the map generation unit 17 determines through pattern matching process, etc., that the camera image includes predetermined landscape features (e.g., division lines of a road, traffic signals, traffic signs, etc.) having feature points not used in the calculation of the above three-dimensional positions, it adds position information of points corresponding to the feature points of the landscape feature based on the camera image to the environmental map, and stores it in the memory unit 12.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position recognition (estimation) processing are simultaneously performed in accordance with the algorithm of SLAM technology. The map generation unit 17 can generate the environmental map not only when the vehicle travels in the manual drive mode but also when the vehicle travels in the self-drive mode. If the environmental map has already been generated and stored in the memory unit 12, the map generation unit 17 may update the environmental map based on newly extracted feature points (may be called new feature points) from newly acquired camera image.

Meanwhile, the feature points used for generating the environmental map using the SLAM technology are required to be unique feature points that are easily distinguished from other feature points. On the other hand, actual vehicle control requires the environmental map to include information of a landscape feature such as a road division line. In the embodiment, configuring a map generation apparatus that performs the following processing (1) to (3) allows for appropriate generation of an environmental map including information necessary for vehicle control.
(1) As a feature point used for generating an environmental map, a unique feature point that is easily distinguished from other feature points is selected among feature points extracted from a camera image. This is because if the feature point is not unique, it is difficult to track the same feature point across a plurality of frames of camera image. Therefore, a unique feature point based on edge information of a window frame of a building or the like is preferentially selected while selecting a feature point based on edge information of predetermined landscape features such as road division lines, traffic signs, and traffic signals is avoided since it is difficult to track the same feature point across a plurality of frames of camera image.
(2) Information useful for recognition (estimation) of a subject vehicle position is subsequently added to the environmental map. According to (1) above, information of road division lines and the like necessary for recognition of the subject vehicle position is not included in the environmental map, and thus the information of division lines and the like is subsequently added to the environmental map (which may be referred to as embedding).
(3) If the environmental map is corrected, the information substituted for the information subsequently added in (2) above is added again. Generally, the SLAM technology accumulates errors because the subject vehicle position is recognized while the subject vehicle is moving. For example, when the subject vehicle travels around a closed square road, the positions of start and end points do not match due to accumulated errors. Therefore, if it is recognized that a traveling position of the subject vehicle is on a past travel trajectory, loop closing processing is executed to make the coordinates of the subject vehicle position recognized using feature points extracted from a camera image newly acquired (referred to as new feature points) at the same traveling point as in the past the same as the coordinates of the subject vehicle position recognized in the past using feature points extracted from a camera image acquired at the past traveling time. In the embodiment, the loop closing processing is referred to as environmental map correction, by which information of three-dimensional positions included in the environmental map is corrected. At this time, the information added in (2) above is deleted and the information of the new feature points is added again to the corrected environmental map.

The map generation apparatus that executes the above processing (1) to (3) will be described in more detail.

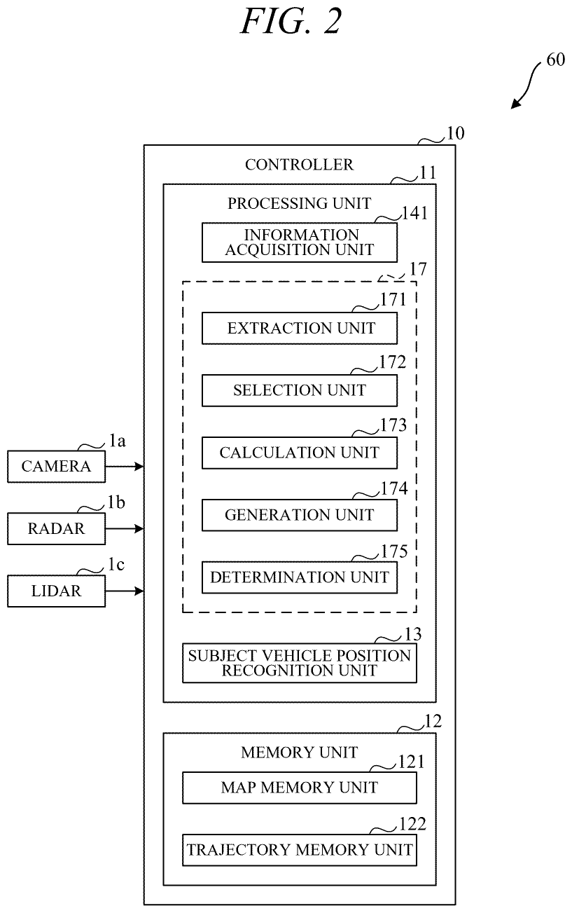

FIG. 2 is a block diagram illustrating a main configuration of a map generation apparatus 60 according to the embodiment. The map generation apparatus 60 is used to control traveling operation of the subject vehicle and constitutes a part of the vehicle control system 100 of FIG. 1. As illustrated in FIG. 2, the map generation apparatus 60 includes the controller 10, a camera 1a, a radar 1b, and a LiDAR 1c.

The camera 1a constitutes a part of the external sensor group 1 of FIG. 1. The camera 1a may be a monocular camera or a stereo camera, and captures images of surroundings of the subject vehicle. The camera 1a is attached to, for example, a predetermined position at the front of the subject vehicle, continuously captures an image of a space in front of the subject vehicle at a predetermined frame rate, and sequentially outputs frame image data (simply referred to as a camera image) as detection information to the controller 10.

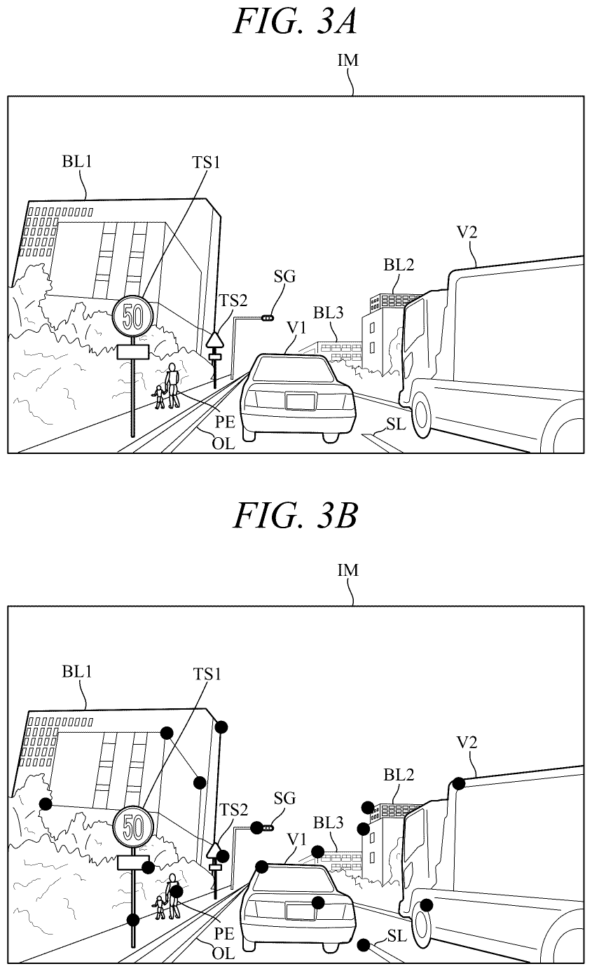

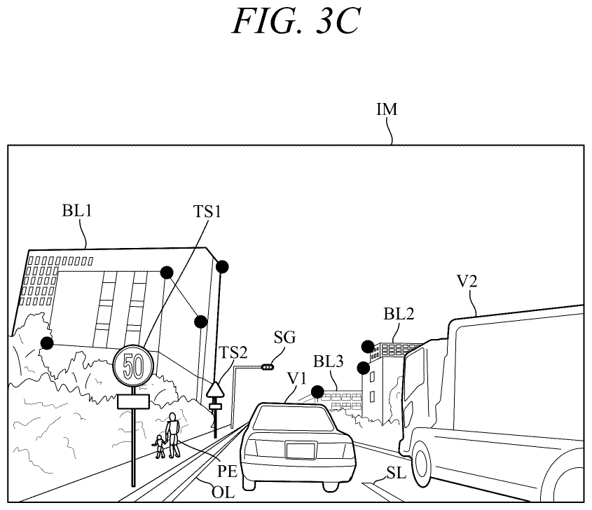

FIG. 3A is a diagram illustrating an example of a certain frame of camera image acquired by the camera 1a. The camera image IM includes another vehicle V1 traveling in front of the subject vehicle, another vehicle V2 traveling in a right lane of the subject vehicle, a traffic signal SG around the subject vehicle, a pedestrian PE, traffic signs TS1 and TS2, buildings BL1, BL2, and BL3 around the subject vehicle, a road outside line OL, a lane boundary line SL, and the like.

The radar 1b of FIG. 2 is mounted on the subject vehicle and detects other vehicles, obstacles, and the like around the subject vehicle by emitting electromagnetic waves and detecting reflected waves. The radar 1b outputs detection values (detection data) as detection information to the controller 10. The LiDAR 1c is mounted on the subject vehicle and measures scattered light with respect to irradiation light in all directions of the subject vehicle to detect distances from the subject vehicle to surrounding obstacles. The LiDAR 1c outputs detection values (detection data) as detection information to the controller 10.

The controller 10 includes the processing unit 11 and the memory unit 12. The processing unit 11 includes an information acquisition unit 141, an extraction unit 171, a selection unit 172, a calculation unit 173, a generation unit 174, a determination unit 175, and the subject vehicle position recognition unit 13 as a functional configuration.

The information acquisition unit 141 is included in, for example, the external environment recognition unit 14 of FIG. 1. The extraction unit 171, the selection unit 172, the calculation unit 173, the generation unit 174, and the determination unit 175 are included in, for example, the map generation unit 17 of FIG. 1.

In addition, the memory unit 12 includes a map memory unit 121 and a trajectory memory unit 122.

The information acquisition unit 141 acquires information used for controlling the traveling operation of the subject vehicle from the memory unit 12 (map memory unit 121). In more detail, the information acquisition unit 141 reads landmark information included in an environmental map from the map memory unit 121 and further acquires, from the landmark information, information indicating the position of a division line of a road on which the subject vehicle is traveling and the extending direction of the division line (hereinafter referred to as division line information).

When the division line information does not include the information indicating the extending direction of the division line, the information acquisition unit 141 may calculate the extension direction of the division line based on the position of the division line. Furthermore, the information indicating the position and the extending direction of the division line of the road on which the subject vehicle is traveling may be acquired from road map information, a white line map (information indicating the positions of division lines of white, yellow, etc.), or the like stored in the map memory unit 121.

The extraction unit 171 extracts edges indicating the outlines of objects from the camera image IM (illustrated in FIG. 3A) acquired by the camera 1a, and also extracts feature points using the edge information. As described above, the feature points are, for example, edge intersections. FIG. 3B is a diagram illustrating the feature points extracted by the extraction unit 171 based on the camera image IM of FIG. 3A. Black circles in the figure represent the feature points.

The selection unit 172 selects feature points for calculating three-dimensional positions from among the feature points extracted by the extraction unit 171. In the embodiment, feature points included in landscape features other than predetermined landscape features (for example, road division lines, traffic signals, traffic signs, and the like) are selected as unique feature points that are easily distinguished from other feature points. FIG. 3C is a diagram illustrating the feature points selected by the selection unit 172 based on FIG. 3B. Black circles in the figure represent the feature points. The illustrated predetermined landscape features are examples, and at least one of them may be excluded.

The calculation unit 173 calculates the three-dimensional position for a feature point while estimating the position and posture of the camera 1a so that the same feature point converges to a single point across a plurality of frames of the camera image IM. The calculation unit 173 calculates the respective three-dimensional positions of a plurality of different feature points selected by the selection unit 172.

The generation unit 174 generates an environmental map constituted by three-dimensional point group data including information of the respective three-dimensional positions of the plurality of different feature points using the three-dimensional positions calculated by the calculation unit 173.

The determination unit 175 determines whether or not the environmental map generated by the generation unit 174 is completed. Although details of the determination will be described later, the determination unit 175 determines whether or not the map generated by the generation unit 174 is completed based on difference between the positions of new feature points of the predetermined landscape features extracted based on the camera image IM newly acquired by the camera 1a and the positions of points added to the environmental map stored in the map memory unit 121.

The subject vehicle position recognition unit 13 estimates the subject vehicle position on the environmental map based on the environmental map stored in the map memory unit 121.

First, the subject vehicle position recognition unit 13 estimates the position of the subject vehicle in the vehicle width direction. Specifically, the subject vehicle position recognition unit 13 uses machine learning (deep neural network (DNN), etc.) technology to recognize a road division line included in the camera image IM newly acquired by the camera 1a. The subject vehicle position recognition unit 13 recognizes the position and the extending direction of the division line included in the camera image IM on the environmental map based on the division line information acquired from the landmark information included in the environmental map stored in the map memory unit 121. Then, the subject vehicle position recognition unit 13 estimates a relative positional relationship (positional relationship on the environmental map) between the subject vehicle and the division line in the vehicle width direction based on the position and the extending direction of the division line on the environmental map. In this manner, the position of the subject vehicle in the vehicle width direction on the environmental map is estimated.

Next, the subject vehicle position recognition unit 13 estimates the position of the subject vehicle in the traveling direction. Specifically, the subject vehicle position recognition unit 13 recognizes a landmark (for example, the building BL1) in the camera image IM (FIG. 3A) newly acquired by the camera 1a by processing such as pattern matching, and also recognizes feature points on that landmark from among the feature points extracted by the extraction unit 171. Furthermore, the subject vehicle position recognition unit 13 estimates the distance in the traveling direction from the subject vehicle to the landmark based on the positions of the feature points of the landmark appearing in the camera image IM. The distance from the subject vehicle to the landmark may be calculated based on a detection value of the radar 1b or the LiDAR 1c.

The subject vehicle position recognition unit 13 searches for feature points corresponding to the above-described landmark in the environmental map stored in the map memory unit 121. In other words, feature points matching the feature points of the landmark recognized in the newly acquired camera image IM are recognized from among a plurality of feature points (point group data) constituting the environmental map.

Next, the subject vehicle position recognition unit 13 estimates the position of the subject vehicle in the traveling direction on the environmental map based on the positions of the feature points on the environmental map corresponding to the feature points of the landmark and the distance from the subject vehicle to the landmark in the traveling direction.

As described above, the subject vehicle position recognition unit 13 recognizes the subject vehicle position on the environmental map based on the estimated positions of the subject vehicle in the vehicle width direction and the traveling direction on the environmental map.

The map memory unit 121 stores information of the environmental map generated by the generation unit 174.

The trajectory memory unit 122 stores information indicating travel trajectories of the subject vehicle. The travel trajectory is represented, for example, as the subject vehicle position on the environmental map recognized by the subject vehicle position recognition unit 13 during traveling.

### <Description of Flowchart>

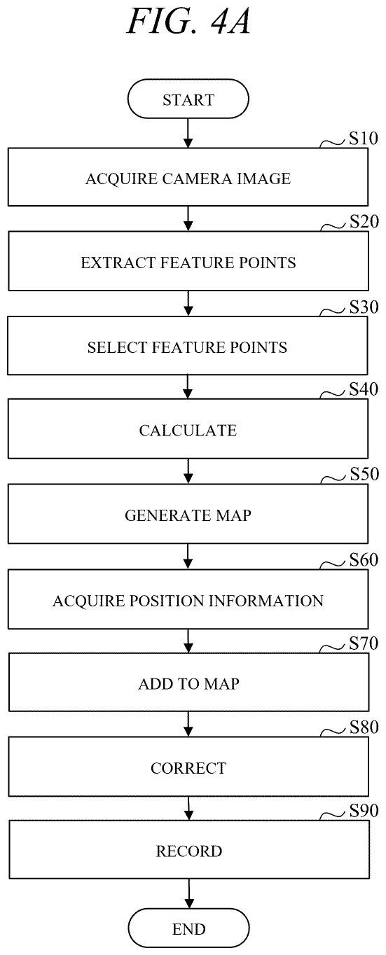

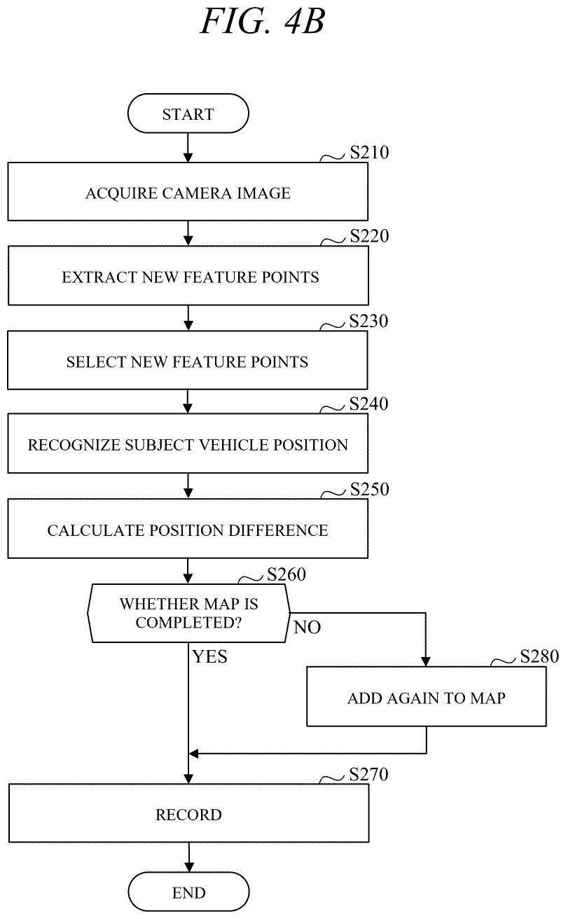

An example of processing executed by the controller 10 of FIG. 2 according to a predetermined program will be described with reference to flowcharts of FIGS. 4A and 4B. FIG. 4A illustrates processing before an environmental map is generated, which is started in, for example, the manual drive mode and repeated at a predetermined cycle. FIG. 4B illustrates processing executed in parallel with the map generation processing of FIG. 4A. FIG. 4B is started in, for example, the self-drive mode after the environmental map is generated, and repeated at a predetermined cycle.

In step S10 of FIG. 4A, the controller 10 acquires a camera image IM as detection information from the camera 1a, and proceeds to step S20.

In step S20, the controller 10 causes the extraction unit 171 to extract feature points from the camera image IM, and proceeds to step S30.

In step S30, the controller 10 causes the selection unit 172 to select feature points, and proceeds to step S40. As described above, it is possible to select unique feature points that are easily distinguished from other feature points by selecting feature points included in landscape features other than road division lines, traffic signals, traffic signs, and the like.

In step S40, the controller 10 causes the calculation unit 173 to calculate the respective three-dimensional positions of a plurality of different feature points, and proceeds to step S50.

In step S50, the controller 10 causes the generation unit 174 to generate an environmental map constituted by three-dimensional point group data including information of the respective three-dimensional positions of the plurality of different feature points, and proceeds to step S60.

In step S60, the controller 10 acquires position information of landscape features having feature points not selected in step S30 among the feature points extracted in step S20, in other words, position information (distances from the subject vehicle to the landscape features) of the above-described predetermined landscape features (road division lines, traffic signals, traffic signs, and the like), and proceeds to step S70. This position information is acquired by estimating the distances from the subject vehicle to the landscape features based on the positions of the feature points of the landscape features appearing in the camera image IM. The distances from the subject vehicle to the landscape features may be acquired based on detection values of the radar 1b or the LiDAR 1c.

In step S70, the controller 10 adds information of points corresponding to the feature points of the above-described landscape features to the point group data of the environmental map, and proceeds to step S80. With this configuration, information of landscape features such as division lines is embedded in the environmental map. Adding the information of division lines, traffic signals, and traffic signs to the environmental map makes it possible to provide information of the positions of division lines, traffic signals, and traffic signs visible from the subject vehicle position estimated based on the information of the environmental map to the subject vehicle based on the information of the environmental map.

In step S80, if recognizing that the traveling position of the subject vehicle is on a past travel trajectory, the controller 10 corrects the information of the three-dimensional positions included in the environmental map by loop closing processing described above, and proceeds to step S90.

In step S90, the controller 10 records the information of the environmental map in the map memory unit 121 of the memory unit 12, and ends the processing according to FIG. 4A.

In step S210 of FIG. 4B, the controller 10 acquires a camera image IM as detection information from the camera 1a, and proceeds to step S220.

In step S220, the controller 10 causes the extraction unit 171 to extract new feature points from the camera image IM, and proceeds to step S230. The feature points extracted in the processing of FIG. 4B are referred to as new feature points even if they are points on the same objects as the feature points extracted in the processing of FIG. 4A.

In step S230, the controller 10 causes the selection unit 172 to select new feature points, and proceeds to step S240. In step S230, new feature points based on edge information of the predetermined landscape features (road division lines, traffic signs, traffic signals, and the like) and new feature points based on edge information of buildings and the like that are not the predetermined landscape features are selected.

In step S240, the controller 10 causes the subject vehicle position recognition unit 13 to recognize (estimate) the subject vehicle position based on the environmental map, and proceeds to step S250.

In step S250, the controller 10 calculates position difference, and proceeds to step S260. The position difference is difference between the positions of the new feature points of the predetermined landscape features selected in step S230 and the positions of the points corresponding to the feature points of the predetermined landscape features, which have been added to the environmental map in step S70. The position information of the new feature points of the predetermined landscape features is acquired by estimating the distances from the subject vehicle to the division lines and the like based on, for example, the positions of the division lines and the like appearing in the camera image IM. The distances from the subject vehicle to the division lines and the like may be acquired based on detection values of the radar 1b or the LiDAR 1c.

In step S260, the controller 10 determines whether or not the environmental map is completed. If the position difference is equal to or smaller than a predetermined allowable value, the controller 10 makes an affirmative determination in step S260, and proceeds to step S270. In this case, it is assumed that the environmental map is completed for an area where the subject vehicle has traveled during the processing of FIG. 4B, and the environmental map is allowed to be used for vehicle control in self-driving in this area.

On the other hand, if the position difference exceeds the predetermined allowable value, the controller 10 makes a negative determination in step S260, and proceeds to step S280. In this case, it is determined that the environmental map is not completed for the area where the subject vehicle has traveled during the processing of FIG. 4B, and the environmental map is not allowed to be used for the vehicle control in self-driving in this area.

In step S280, the controller 10 deletes the information added to the environmental map in step S70, adds again the position information of the new feature points of the predetermined landscape features selected in step S230 to the environmental map, and proceeds to step S270.

According to the above-described embodiment, the following effects can be achieved.
(1) A map generation apparatus 60 includes: an extraction unit 171 configured to extract a feature point from a camera image IM as detection information detected by a camera 1a as an in-vehicle detector that detects a situation around a subject vehicle; a selection unit 172 configured to select a feature point to be used for calculation by a calculation unit 173 from a plurality of feature points extracted by the extraction unit 171; the calculation unit 173 configured to calculate a three-dimensional position of a same feature point included in a plurality of frames of the camera image IM for each of a plurality of different feature points selected by the selection unit 172 using a position and posture of the camera 1a based on the plurality of frames of the camera image IM; and a generation unit 174 configured to generate an environmental map including information of respective three-dimensional positions of the plurality of different feature points using the three-dimensional positions calculated by the calculation unit 173, in which the selection unit 172 is configured to select a feature point other than feature points of a predetermined landscape feature, and the generation unit 174 is configured to add information of points corresponding to feature points not selected by the selection unit 172 to the generated environmental map.

With this configuration, information of division lines and the like useful for recognition (estimation) of the subject vehicle position can be included in the environmental map while preferentially selecting unique feature points (for example, feature points based on edge information of a window frame of a building or the like) that are easy to track across a plurality of frames of the camera image IM and avoiding selecting feature points (for example, feature points based on edge information of the predetermined landscape features such as road division lines, signs, and signals) that are difficult to track across the plurality of frames of the camera image IM allows for suppressing the number of feature points used for generation of the environmental map.

In this manner, an environmental map necessary for safe vehicle control can be appropriately generated.
(2) The map generation apparatus 60 according to the above (1) further includes: a map memory unit 121 configured to store the generated environmental map; a subject vehicle position recognition unit 13 as a position estimation unit that estimates a position of the subject vehicle by collating new feature points extracted by the extraction unit 171 from the camera image IM newly detected by the camera 1a with feature points in the environmental map stored in the map memory unit 121; and a trajectory memory unit 122 configured to store a past travel trajectory of the subject vehicle, in which the generation unit 174 is configured to correct, when a position where the subject vehicle is traveling is on a travel trajectory stored in the trajectory memory unit 122, information of the environmental map so that the position of the subject vehicle estimated by the subject vehicle position recognition unit 13 using the new feature points matches a position of the subject vehicle estimated by the subject vehicle position recognition unit 13 at a past traveling time.

With this configuration, the information included in the environmental map can be corrected by appropriately performing the loop closing processing. As a result, an environmental map necessary for safe vehicle control can be appropriately generated.
(3) The map generation apparatus 60 according to the above (2) further includes a determination unit 175 configured to determine whether or not the environmental map is completed based on difference between positions of new feature points of road division lines, traffic signs, traffic signals, and the like as the predetermined landscape feature acquired based on the camera image IM newly detected by the camera 1a and positions of the points corresponding to the feature points (feature point of division lines, traffic signs, traffic signals, and the like) not selected by the selection unit 172, the points having being added to the environmental map stored in the map memory unit 121.

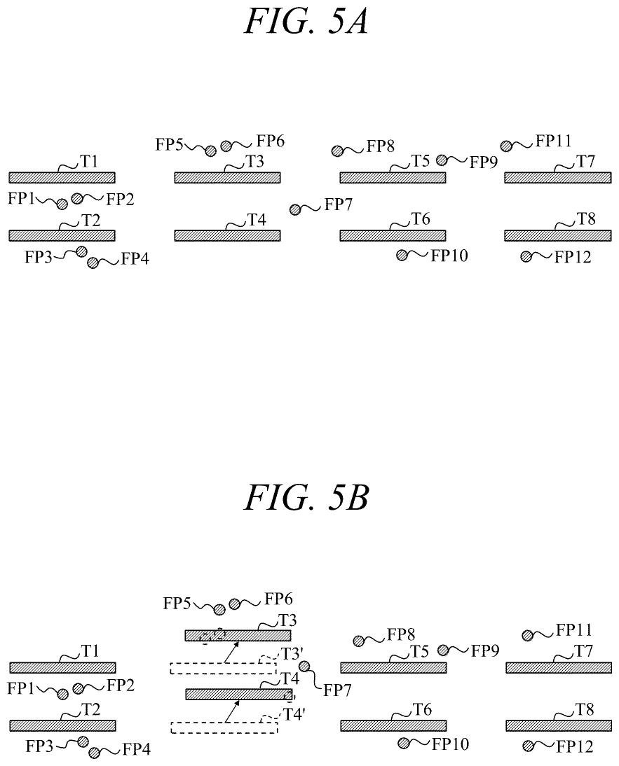

With this configuration, the controller 10 can appropriately determine whether or not the environmental map is completed. A reason for this will be described with reference to FIGS. 5A and 5B.

FIG. 5A is a schematic diagram illustrating information included in the environmental map at the time when the processing of step S70 ends, and FIG. 5B is a schematic diagram illustrating the information included in the environmental map at the time when the processing of step S80 ends. In FIG. 5A, circles denoted by reference signs FP1 to FP12 indicate feature points constituting the environmental map, and shapes denoted by reference signs T1 to T8 indicate points added to the environmental map in the processing of step S70 (points corresponding to division lines in the camera image IM).

Assume that the feature points denoted by reference signs FP5 to FP7 in FIG. 5A among the feature points constituting the environmental map are respectively moved to the positions of reference signs FP5 to FP7 in FIG. 5B by the correction processing of step S80. The points T3 and T4 corresponding to division lines, which have been added using the positions of the nearest feature points FP5 to FP7 as reference positions, respectively move to the positions indicated by reference signs T3 and T4 in FIG. 5B along with the movement of the positions of the feature points FP5 to FP7.

If the positions of the points T3 and T4 corresponding to the division lines move beyond a predetermined allowable range, the determination unit 175 determines that the environmental map generated by the generation unit 174 is not completed. In this case, it is necessary to add again points T3′ and T4′ corresponding to the division lines newly acquired based on the camera image IM using the positions of the moved feature points FP5 to FP7 as reference positions.

On the other hand, if the positions of the points T3 and T4 corresponding to the division lines move to positions within the predetermined allowable range, the determination unit 175 determines that the environmental map generated by the generation unit 174 is completed. In this case, it is not necessary to add again the points T3′ and T4′ corresponding to the division lines newly acquired based on the camera image IM using the positions of the moved feature points FP5 to FP7 as reference positions.

As described above, the controller 10 can appropriately determine whether or not the environmental map is completed.
(4) In the map generation apparatus 60 according to the above (3), the generation unit 174 is configured to, when the determination unit 175 determines that the environmental map is not completed (No in step S260), add information of points (T3′ and T4′) corresponding to the new feature points of road division lines, traffic signs, traffic signals, and the like as the predetermined landscape feature to the corrected map, in place of the information of the points (T3 and T4) corresponding to the feature points (feature points of division lines, traffic signs, traffic signals, and the like) not selected by the selection unit 172.

With this configuration, if the points T3 and T4 corresponding to the division lines move beyond the allowable range along with the movement of the positions of the feature points FP5 to FP7 moved by the correction of the information of the environmental map, the points T3′ and T4′ corresponding to the division lines newly acquired based on the camera image IM can be added again to the environmental map.

This makes it possible to provide information of the positions of division lines, traffic signals, and traffic signs visible from the subject vehicle position estimated based on the information of the corrected environmental map to the subject vehicle based on the information of the corrected environmental map.
(5) In the map generation apparatus 60 according to the above (1) to (4), the selection unit 172 is configured not to select a feature point of at least one of a road division line, a traffic signal, and a traffic sign.

With this configuration, information of division lines and the like useful for recognition (estimation) of the subject vehicle position can be included in the environmental map while preferentially selecting unique feature points (for example, feature points based on edge information of a window frame of a building or the like) that are easy to track across a plurality of frames of the camera image IM and avoiding selecting feature points based on edge information of road division lines, traffic signs, traffic signals, and the like that are difficult to track across the plurality of frames of the camera image IM allows for suppressing the number of feature points used for generation of the environmental map.

The above embodiment can be varied into various forms. Hereinafter, modifications will be described.

### (Modification 1)

As examples of the predetermined landscape features for which the selection unit 172 does not select feature points based on the camera image IM, road division lines, traffic signs, and traffic signals are described. However, for objects that are difficult to track across a plurality of frames of camera images IM, it is also possible to configure not to select feature points for another landscape feature other than the landscape features described above.

### (Modification 2)

In the embodiment, for clarity, the processing illustrated in FIG. 4A is described as a processing before the environmental map is generated, for convenience. However, even after the environmental map has been generated (after it has been determined that the environmental map is completed), the processing illustrated in FIG. 4A may be performed in parallel with the subject vehicle position recognition processing in FIG. 4B. By also performing it after the completion of the environmental map, for example, in case of changes in the road environment, it becomes possible to appropriately add that information to the environmental map.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

1a camera, 1b radar, 1c LiDAR, 10 controller, 11 processing unit, 12 memory unit, 13 subject vehicle position recognition unit, 14 external environment recognition unit, 17 map generation unit, 60 map generation apparatus, 121 map memory unit, 122 trajectory memory unit, 171 extraction unit, 172 selection unit, 173 calculation unit, 174 generation unit, 175 determination unit, BL1-BL3 building, FP1-FP12 feature point, IM camera image, OL road outside line, SG traffic signal, SL lane boundary line, T1-T8,T3′,T4′ point, TS1,TS2 traffic sign, V1,V2 other vehicle

1-5. (canceled)

6. A map generation apparatus, comprising:
an in-vehicle detector configured to detect a situation around a subject vehicle; and
an electronic control unit including a microprocessor and a memory connected to the microprocessor, wherein
the microprocessor is configured to perform:
extracting feature points from detection information detected by the in-vehicle detector;
selecting a plurality of first feature points different from each other from the feature points;
calculating three-dimensional positions of the plurality of first feature points included in each of a plurality of the detection information while estimating a position or posture of the in-vehicle detector based on the plurality of the detection information; and
generating a map including information on the three-dimensional positions of the plurality of first feature points, and wherein
the microprocessor is configured to perform
the selecting including selecting the plurality of first feature points other than a feature point of a predetermined landscape feature from the feature points, and
the generating including adding information on a position of a second feature point not selected among the feature points to the map.

7. The map generation apparatus according to claim 6, wherein
the memory is configured to store the map including information on positions of the plurality of first feature points and the information on the position of the second feature point, and a past travel trajectory of the subject vehicle, the microprocessor is configured to perform
the extracting including extracting a new feature point from new detection information newly detected by the in-vehicle detector after the memory stores the map, and
further estimating a position of the subject vehicle by collating the new feature point with the plurality of first feature points or the second feature point included in the map, and wherein
the microprocessor is configured to perform
the generating including correcting information of the map so that the position of the subject vehicle estimated using the new feature point matches the position of the subject vehicle estimated at a past traveling time when a position where the subject vehicle travels is on the past travel trajectory stored in the memory.

8. The map generation apparatus according to claim 7, wherein
the microprocessor is configured to further perform
determining whether the map is completed based on a difference between a position of the new feature point of the predetermined landscape feature acquired based on the new detection information and the position of the second feature point stored in the memory.

9. The map generation apparatus according to claim 8, wherein
the microprocessor is configured to perform
the generating including adding information on the position of the new feature point in place of the information on the position of the second feature point to the map corrected, when it is determined that the map is not completed.

10. The map generation apparatus according to claim 6, wherein
the microprocessor is configured to perform
the selecting including not selecting a feature point corresponding to at least one of a division line of a road, a traffic signal and a traffic sign.

11. The map generation apparatus according to claim 6, wherein
the in-vehicle detector is a camera, and
the microprocessor is configured to perform
the calculating including calculating the three-dimensional positions of the plurality of first feature points included in each of a plurality of frames of a camera image while estimating a position or posture of the camera based on the plurality of frames of the camera image.

12. The map generation apparatus according to claim 7, wherein
the microprocessor is configured to perform
the generating including correcting the information on the positions of the plurality of first feature points included in the map by performing a loop closing processing so that the position of the subject vehicle estimated using the new feature point matches the position of the subject vehicle estimated at the past traveling time when the position where the subject vehicle travels is on the past travel trajectory stored in the memory, and further correcting the information on the position of the second feature point included in the map in accordance with a correction of the information on the positions of the plurality of first feature points.
